(19) United States
(12) Patent Application Publication
(10) Pub. No.: US 2014/0278957 A1
(43) Pub. Date: Sep. 18, 2014

(54) NORMALIZATION OF MEDIA OBJECT METADATA

(71) Applicant: Deja.io, Inc., San Francisco, CA (US)

(72) Inventors: Nimrod Ram, Tel-Aviv-Yaffo (IL); John Root Stone, San Francisco, CA (US); Avner Shilo, Oakland, CA (US); Lucas Heldfond, San Francisco, CA (US)

(73) Assignee: Deja.io, Inc., San Francisco, CA (US)

(21) Appl. No.: 14/209,631

(22) Filed: Mar. 13, 2014

Related U.S. Application Data
(60) Provisional application No. 61/779,315, filed on Mar. 13, 2013.

(51) Int. Cl. G06Q 30/02; G06F 17/30

(52) U.S. Cl. CPC G06Q 30/0251; G06F 17/30784; G06F 17/30011
USPC 705/14.49; 707/736; 707/748

(57) ABSTRACT

Disclosed is the technology for normalizing media object metadata. The technology receives a plurality of web documents from web servers. The web documents reference one or more media objects. Then the technology extracts content tags from the web documents, wherein the content tags relate to contents of the media objects. The technology determines a set of media object metadata based on the content tags. The set of media object metadata provides a consistent way of describing the contents of the media objects. For at least some of the media objects, the technology stores the set of media object metadata and the values associated with the media object metadata in a media content database.

### CROSS-REFERENCE TO RELATED APPLICATION

This application claims the benefit of U.S. Provisional Patent Application No. 61/779,315, entitled “COMPUTER READABLE STORAGE MEDIA, APPARATUSES, SYSTEMS, AND METHODS FOR CATALOGING MEDIA CONTENT AND PROVIDING MEDIA CONTENT”, which was filed on Mar. 13, 2013, which is incorporated by reference herein in its entirety.

### BACKGROUND

The traditional manner of recommending media content is inefficient to both users and content providers. For instance, a content provider may manually create categories for the media content and manually assign media content to the categories. When the content provider detects that a user has consumed one or more instances of media content of a particular category, the content provider may recommend more media content within the same category to the user. Such a recommendation is not accurate because the user may not be interested in other media contents within that particular category. Furthermore, this type of recommendation ignores the varied interests of users which results in the user receiving recommendations from the content provider that are of little interests to the user.

Alternatively, the content provider may present thumbnails of the media content to the user. The user can select one of the thumbnails as an indication of an interest in the media content. However, thumbnails provide little information regarding the actual media content. The user may discover later that the user is not really interested in the media content selected based on the thumbnail. Such a media content selection process is inefficient and cumbersome.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates an environment in which the media content analysis technology can be implemented.

FIG. 2 illustrates an example of a process of analyzing web documents and generating global tags.

FIG. 3 illustrates an example of a process of categorizing a media object based on web documents referencing the media object.

FIG. 4 illustrates an example of a process of generating affinity values between a media object and users.

FIG. 5 illustrates an example of a process of aggregating various types of media content metadata.

FIG. 6 illustrates an example of a process of determining feature vectors based on metadata of media objects.

FIG. 7 illustrates an example of a process of recommending a media object to a user.

FIG. 8 illustrates another example of a process of recommending a media object.

FIG. 9 illustrates an example of a client device receiving a media object recommendation.

FIG. 10 illustrates an example process for pre-caching online media objects.

FIG. 11 illustrates an example graphical interface for seamless media object navigation.

FIG. 12 illustrates an example process for seamless media object navigation.

FIG. 13 illustrates an example process for normalizing media object metadata,

FIG. 14 is a high-level block diagram showing an example of a processing system in which at least some operations related to media content analysis and recommendation, media object metadata normalization, media object buffering, or seamless media navigation can be implemented.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive.

Online media content providers supply metadata (tags) associated with the online media objects (e.g., videos or audios) to identify, describe and classify the contents of the media objects. These metadata are usually supplied in ways that are unique and specific to the content providers. A technology is provided herein to collect the metadata from various content providers and normalize these source specific metadata into a group of universal tags for the online media objects regardless of the source content providers or the media types. Furthermore, the technology retrieves online messages referencing the media objects (e.g., posts, comments, blogs, RSS feeds, etc.) and parses these messages for collecting metadata associated with the media objects. For instance, the technology may provide one or more templates for each social media platform which define textual patterns for locating the metadata. The universal tags enable the online media objects to be organized and categorized based on a consistent way of identifying and describing the contents of the objects across various media content provider platforms.

FIG. 1 illustrates an environment in which the media content analysis technology can be implemented. The environment includes a media content analysis system 100. The media content analysis system 100 is connected to client devices 192 and 194 (also referred to as “client” or “customer”). The client device 192 or 194 can be, for example, a smart phone, tablet computer, notebook computer, or any other form of mobile processing devices. The media content analysis system 100 can further connect to various servers including, e.g., media content delivery server 180, social media server 182, general content server 184. The general content server 184 can provide, e.g., news, images, photos, or other media types. Each of the aforementioned servers and systems can include one or more distinct physical computers and/or other processing devices which, in the case of multiple devices, can be connected through one or more wired and/or wireless networks.

The media content delivery server 180 can be a server that hosts and delivers, e.g., media files or media streams. The media content delivery server 180 may further host webpages that provide information regarding the contents of the media files or streams. The media content delivery server 180 can also provide rating and commenting web interfaces for users to rate and comment on the media files or streams.

A social media server 182 can be a server that hosts a social media platform. Users can post messages discussing various topics, including media objects, on the social media platform. The posts can reference media objects that are hosted by the social media server 182 itself or media objects that are hosted externally (e.g., by the media content delivery server 180).

A general content server 184 can be a server that serves web documents and structured data to client devices or web browsers. The content can reference media objects that are hosted online. The media content analysis system 100 may connect to other types of server that hosts web documents that reference media objects.

The media content analysis system 100 can be coupled to the client devices 192 and 194 though an internetwork (not shown), which can be or include the Internet and one or more wireless networks (e.g., a WiFi network and or a cellular telecommunications network). The servers 180, 182 and 184 can be coupled to the media content analysis system 100 through the internetwork as well. Alternatively, one or more of the servers 180, 182 and 184 can be coupled to the media content analysis system 100 through one or more dedicated networks, such as a fiber optical network.

The client devices 192 and 194 can include API (application programming interface) specifications 193 and 196 respectively. The API specifications 193 and 196 specify the software interface through which the client devices 192 and 194 interact with the client service module 170 of the media content analysis system 100. For instance, the API specifications 193 and 196 can specify the way how the client devices 192 and 194 request media recommendation from the client service module 170. Alternatively, the API specifications 193 and 196 can specify the way how the client devices 192 and 194 retrieve media object metadata from the client service module 170.

The media content analysis system 100 collects various types of information regarding media contents from the servers 180, 182 and 184. The media content analysis system 100 aggregates and analyzes the information. Through the analysis, the media content analysis system 100 generates and stores metadata regarding the contents of the media objects. Using the metadata, the media content analysis system 100 can provide various types of service associated with media objects to the client devices 192 and 194. For instance, based on media objects that the client device 192 has played, a client service module 170 of the media content analysis system 100 can recommend similar or related media objects to the client device 192. Media objects can include, e.g., a video file, a video stream, an audio file, an audio stream, an image, a game, an advertisement, a text, or a combination thereof. A media object may include one or more file-type objects or one or more links to objects. To analyze the information related to the contents of the media objects, the media content analysis system 100 can include, e.g., a global tag generator 120, a NLP (Natural Language Processing) classifier 130, a behavior analyzer 140, a numeric attribute collector 150, a metadata database 160 and a client service module 170. The global tag generator 120 is responsible for generating tags by parsing web documents through templates that are specific to the web domains. The web documents can include, e.g., HyperText Markup Language (HTML) documents; Extensible Markup Language (XML) documents; JavaScript Object Notation (JSON) documents; Really Simple Syndication (RSS) documents; or Atom Syndication Format documents.

The NLP classifier 130 is responsible for classifying the media objects into pre-determined categories. By feeding textual contents of the web documents, the NLP classifier 130 is configured to provide category weight values that indicate confidence levels which confirming a particular media object belongs to certain categories. In alternative embodiments, the media content analysis system 100 can include a classifier other than the NLP classifier to categorize the media objects based on the contents of the web documents as well.

The behavior analyzer 140 monitors and analyses online users' behaviors associated with media objects in order to generate affinity values that indicate the online users' interest in certain media objects.

The numeric attribute collector 150 is responsible for collecting non-textual or numerical metadata regarding the media objects from the web documents. Such non-textual or numerical metadata can include, e.g., view counts, media dimensions, media object resolutions, etc.

The metadata database 160 is responsible for organizing and storing the media content metadata generated by the global tag generator 120, the NLP classifier 130, the behavior analyzer 140 and numeric attribute collector 150. For instance, using the metadata stored in the metadata database 160, the client service module 170 may identify two similar or related media objects and, based on the similarity or relatedness, may recommend one of these media objects to a client device 192 or 194. The following figures illustrate how different types of media content metadata are generated.

FIG. 2 illustrates an example process for analyzing web documents and generating global tags, according to various embodiments. The process can be performed by, e.g., the global tag generator 120 of the media content analysis 100. Initially the media content analysis system 100 receives web documents 210 that relate to or reference one or more media objects from external servers, such as media content delivery server 180, social media server 182, general content server 184. The media content analysis system 100 can retrieve and analyze different types of web documents 210, including HyperText Markup Language (HTML) documents; Extensible Markup Language (XML) documents; JavaScript Object Notation (JSON) documents; Really Simple Syndication (RSS) documents; or Atom Syndication Format documents.

The web documents are fed into one or more specific parser template of the global tag generator 120 to generate raw tags. Each specific parser template is specifically designed for a particular web domain. In some embodiments, the specific parser template is automatically generated based on the document formality of the particular web domain. The specific parser template can be further updated dynamically based on the formality of the received web documents.

The specific tag generator 120 determines a web domain that hosts a particular web document, and uses a template 220 specific to the web domain for parsing the particular web document. For instance, a social media website may host a social media comment discussing a video. The specific tag generator 120 can use a template 220 specifically designed for the social media website for parsing the social media comment and extracting the tags.

The specific parser template 220 can include a protocol parser 222 or more protocol parsers. Different types of web documents are formatted under different protocols. The specific tag generator 120 uses the protocol parser 222 to identify the textual contents of the web documents. For instance, the protocol parser 222 can retrieve the contents of a HTML document by ignoring texts outside of the <body> element and removing at least some of the HTML tags.

The specific parser template 220 can further include a regular expression (“RegEx”) tag extractor 224. The RegEx tag extractor 224 specifies rules to extract raw tags 230 from the web documents. For instance, the RegEx tag extractor 224 can define a search pattern for HTML documents from a particular web domain to locate textual strings that match the search pattern to capture the tags and the unstructured text.

The global tag generator 120 uses a preliminary processor 240 to perform preliminary processing on the generated raw tags 230. For instance, the preliminary processor 240 can perform typo (i.e., typographical error) correction 242 on the raw tags, If a raw tag is not found in a dictionary, the raw tag is compared to the existing words in the dictionary by, e.g., calculating Levenshtein distances between the raw tag and the existing words. A Levenshtein distance is a string metric for measuring the difference between a raw tag and an existing word. If the Levenshtein distance is below a threshold value, the preliminary processor 240 identifies the raw tag as having a typo and replaces the raw tag with an existing word.

The preliminary processor 240 can further perform common words exclusion 244 by accessing a dictionary including common words (not necessarily the same dictionary used for typo correction 242). If a raw tag belongs to the common words identified by the dictionary, the preliminary processor 240 can exclude that raw tag from further analysis.

The preliminary processor 240 can also perform stemming and lemmatization processes 246 on the raw tags 230. The preliminary processor 240 may reduce a raw tag from an inflected or derived word to a stem word form (i.e., stemming process). For instance, the preliminary processor 240 may reduce “dogs” to a stem form of “dog”, “viewed” to “view”, and “playing” to “play”. The preliminary processor 240 may further group raw tags as different forms of a word together as a single raw tag (i.e., lemmatization process). For instance, raw tags “speaking”, “speaks”, “spoke” and “spoken” can be lemmatized into a single raw tag “speak”.

The preliminary processor 240 can further perform a word sense disambiguation process 248, e.g., a Yarowsky process, on the raw tags 230. A raw tag may exhibit more than one sense in different contexts. The disambiguation process 248 can feed contextual texts of a raw tag into a pre-trained disambiguation classifier to identify the word senses (e.g., meanings) of the raw tag.

In some embodiments, affinity values (illustrated in FIG. 4) associated with a media object can be used to refine the process of generating global tags. For instance, when the preliminary processor 240 performs the disambiguation 248 on the raw tags 230, the preliminary processor 240 may consider word senses that are popular in other media objects that share strong affinities with the same user subset.

After the raw tags 230 are preliminarily processed by the preliminary processor 240, the global tag generator 120 uses a confidence weight assessor 250 to assess the raw tags. The confidence weight assessor 250 may assess various factors of the raw tags 230. For instance, the confidence weight assessor 250 may calculate a term frequency—inverse document frequency (TF-IDF) 252 for each raw tag. The TF-IDF is a numeral indicating the significance of a raw tag to a web document. The TF-IDF value increases proportionally to the number of times a raw tag appears in the web document, but is offset by the frequency of the word in a corpus. The corpus is the collection of all extracted tags, which help to control for the fact that some raw tags are generally more common than other tags.

The confidence weight assessor 250 can take into account the various confidence values generated during the work of the preliminary preprocessor 240 to generate an aggregated process confidence value 254. For example, if a typo correction 242 was performed on the original tag, the value of the Levenshtein distance between the original and corrected form can be used as an inverse confidence level.

For each raw tag, the confidence weight assessor 250 can calculate a confidence weight value based on the factors (e.g., the TF-IDF value 252 and the aggregated process confidence value 254). The confidence weight value associated with a tag indicates how closely the tag relates to the media object being referenced by the web document.

The global tag generator 120 then performs a ranking process 260 on the raw tags based on the confidence weight values. The global tag generator 120 may select a number of tags from the top of the ranked list as global tags 270 for the media object. The global tags 270 and their associated confidence weight values are stored in the metadata database 160 as part of the metadata of the media object. In other words, the web documents can include unstructured information regarding the contents of the media object. The global tags 270 can be structured information regarding the contents of the media object.

Besides the global tags, the media content analysis system 100 can also categorize a media object based on the web documents that reference the media object. FIG. 3 illustrates an example of a process of categorizing a media object based on web documents that reference the media object, according to various embodiments. The process can be performed by, e.g., the NLP classifier 130 of the media content analysis 100. Initially the media content analysis system 100 receives web documents 310 that reference the media object from one or more external servers, such as media content delivery server 180, social media server 182 or general content server. The media content analysis system 100 can retrieve and analyze different types of web documents 310, including, e.g., HTML, XML, JSON, RSS or ATOM documents.

The web documents 310 are fed into one or more protocol parsers 320. The protocol parser 320 recognizes the protocols used to format the web documents 310 and identifies the textual contents 330 of the web documents 310 based on the recognized protocols. For instance, the protocol parser 320 can recognize a RSS document and extract actual textual contents of the document based on the RSS protocol and standard. The protocol parser 320 may be the same protocol parser 222 used by the global tag generator 120, or may be a parser different from the protocol parser 222.

The extracted textual contents 330 are fed into a trained classifier 340 to identify the categories to which the media object belongs. The classifier 340 can include multiple sets of categories. Using training set data that have determined categories, the classifier 340 is trained for these categories. For each category, the trained classifier 340 provides a category weight value based on the fed textual contents. The category weight value indicates whether the media object belongs to the associated category. The category weight values 350 are stored in the metadata database 160 as part of the metadata of the media object.

In some embodiments, there can be a feedback mechanism to refine the accuracy of the classifier. For instance, a human operator can perform the feedback process by manually approving or declining the categorized results (e.g., the category weight values for the categories) from the classifier. Using the approving and declining feedback, the classifier can adjust itself to improve the categorizing accuracy.

In some alternative embodiments, the feedback process can be automatic and without a human operator or supervisor. A rule-based system can compare the categorizing results from the classifier with indicative tags from the process of generating global tags. For instance, the classifier may categorize a media object as FUNNY with a category weigh value of 95% while a HILARIOUS global tag of the same media object has an associated confidence weight value of 10%. This suggests that the classifier may be wrong in predicting the category FUNNY. When the global tag has a confidence weight level inconsistent with the category weight value, the classifier can use this inconsistency as negative training feedback and can adjust itself accordingly to improve the categorizing accuracy.

Besides the global tags and categories, the media content analysis system 100 can also generate affinity values between media objects and users as metadata of the media objects. FIG. 4 illustrates an example of a process of generating affinity values between a media object and users, according to various embodiments. The behavior analyzer 140 of the media content analysis system 100 continues monitoring users' online behaviors with regard to the media object. The users can include clients and third parties. Clients are users who receive media recommendation and other services from the media content analysis system 100. Third parties are users who do not receive media recommendation or other services from the media content analysis system 100 or who are not affiliated with the media content analysis system 100. The behavior analyzer 140 can monitor the user behaviors by retrieving information of users' interaction with the media object from various servers, such as the media content delivery server 180, social media server 182 or general content server.

The behavior analyzer 140 organizes the information of users' interaction as client behavior analytics 470 and third party behavior analytics 472. The behavior analyzer 140 can recognize various types of metrics (i.e., internal behavior data 474) from the client behavior analytics 470. For instance, the internal behavior data 474 may include a view time of the media object. A longer view of the media object suggests the client has a greater interest in the media object. The behavior analyzer 140 may also track when the client skips the media object, suggesting the client's lack of interest in the media object. The internal behavior data 474 may include the number of times a client repeatedly consumes the media object. The behavior analyzer 140 may record social actions, such as that the client likes (e.g., by clicking a “like” link or button) the media object or that the client explicitly rates the media object (e.g., by giving a number of stars).

The behavior analyzer 140 sets an affinity value 480 between the client and the media object by determining a weighted summation of these internal behavioral data 474. The affinity value 480 indicates how closely the client's interest matches the media object.

Similarly, the behavior analyzer 140 can also recognize external behavior data 476 from the third party behavior analytics 472 of a third party. The external behavior data 476 may include the same metrics as, or different metrics from, the metrics of the internal behavioral data 474. The behavior analyzer 140 sets an affinity value 480 between the third party and the media object by determining a weighted summation of these external behavioral data 476. The affinity values 480 and their associated user identities are stored in the metadata database 160 as part of the metadata of the media object.

In some embodiments, the affinity values are generated globally, based on user behaviors toward the media objects on servers across the Internet. For example, user affinities can be generated by collecting reviews of media content on a social media server 182 and using textual sentiment analysis to estimate the affinity between a user and a reviewed media object.

In some alternative embodiments, the affinity values are generated locally, based on user behaviors toward the media objects within a single channel. The locally generated affinity values may be used for recommendations of media objects inside of a particular channel. Alternatively, both locally and globally generated affinity values may be used together for recommending media objects.

FIG. 5 illustrates an example of a process of aggregating various types of media content metadata, according to at least one embodiment. The web document referencing media objects 510 are processed by using, e.g., processes illustrated in FIGS. 2 and 3. For each media object, multiple global tags and their associated confidence weight values are generated as metadata of the media object. The confidence weight value indicates a confidence level confirming whether or not the associated global tag relates to the media object.

Similarly, for each media object, the categories weight values are generated with regard to each category predicted by the NLP classifier (or other types of classifiers). The category weight value indicates a confidence level confirming whether or not the media object belongs to the associated category.

Affinity values between the users and media objects are generated from the users' behaviors interacting with the media objects. For each media object, an affinity value between a user and the media object indicates a confidence level confirming whether or not the user is interested in or relates to the media object.

The numerical attributes of the media objects can also be collected from the web documents referencing the media object. For instance, from a webpage that provides a video stream and lists the resolution of the video stream, the numeric attribute collector can collect the video stream's resolution as a numerical attribute of the video stream.

For each media object, the metadata database 160 organizes and stores the global tags and associated confidence weight values, the categories and associated category weight values, user identifications and associated affinities values, and numeric attributes as metadata of the media object. This information can be represented as a feature vector, with each numeric value representing the weight of the associated dimension (e.g., mapping to global tags, categories and user identifications).

The media content analysis system 100 can utilize the media content metadata to assess a user's relationships with the metadata and the media objects.

FIG. 6 illustrates an example process for determining user feature vectors based on metadata of media objects, according to various embodiments. Given a list of media objects and their respective affinity values with regard to a particular user's history interacting with the media objects, the client service module 170 of the media content analysis system 100 can generate a user feature vector that represent that user's relationships with the metadata.

In the illustrated embodiment, metadata of three video files V1, V2 and V3 are presented. These metadata of video files V1, V2 and V3 can be stored in, e.g., the metadata database 160. The video file V1 has a global tag HILARIOUS with a confidence weight value of 70% (<HILARIOUS, 70%>), and an affinity value of 60% with a user U1 (<U1, 60%>). The video file V2 has a category TRAGEDY with a category weight value of 90% (<TRAGEDY, 90%>), and an affinity value of 85% with the user U1 (<U1, 85%>). The video file V3 has a global tag HILARIOUS with a confidence weight value of 40% (<HILARIOUS, 40%>), a global tag PG13 with a confidence weight value of 95% (<PG13, 95%>), an affinity value of 75% with the user U1 (<U1, 75%>), and an affinity value of 80% with another user U2 (<U2, 80%>).

Each element of the feature vector of a particular user represents a media content metadata, such as a global tag, a category, or a user identification (either the identification of this particular user or an identification of another user). The value of the element represents the particular user's relationship with the metadata represented by the element. In the illustrated embodiment, the feature vector of U1 can have at least four elements. The elements represent the tag HILARIOUS, the tag PG13, the category TRAGEDY, and the user U2.

For instance, a value of an element representing a global tag represents the particular user's relationship with that global tag. In the illustrated embodiment, the value of the element representing the tag HILARIOUS can be calculated as a weighted average of the confidence weight values associated with HILARIOUS for the video files. The affinity values between the user U1 and the video files V1, V2 and V3 serve as the weights. For example, the HILARIOUS element can be (60%*70%+75%*40%)/2=36%,

Similarly the value of the element representing the tag PG13 can be calculated as a weighted average of the confidence weight values associated with PG13 for the video files. The PG13 element can be 75%*95%=71%.

In alternative embodiments, the element values of the feature vector can be calculated in other ways using the global tags with confidence weight values, categories with category weight values, and user identifications with affinity values. For example, the calculation can give more weight to recently viewed media objects. The client service module 170 can, e.g., use a Bayesian estimator to adjust the affinities of the media objects to take into account the time since the media objects were recently viewed and other additional inputs (e.g., repeat counts, social actions, etc.). Thus, the feature vectors are determined in a way biased to “fresher” media objects.

Likewise, a value of an element representing a category represents the particular user's relationship with that category. In the illustrated embodiment, the value of the element representing the category TRAGEDY can be calculated as a weighted average of the category weight values associated with TRAGEDY for the video files. The affinity values between the user U1 and the video files V1, V2 and V3 serve as the weights. For example, the TRAGEDY element can be 85%*90%=77%.

A value of an element (representing a user identification) represents the particular user's relationship with that user. In the illustrated embodiment, the value of the element representing the user U2 can be calculated as a weighted average of the affinity values associated with U2 for the video files. The affinity values between the user U1 and the video files V1, V2 and V3 serve as the weights. For example, the U2 element can be 75%*80%=60%.

The feature vector can be a sparse vector; i.e., some elements of the feature vector can have zero, null, or missing values. The zero value indicates that the particular user has no relationship with certain global tags, categories, or users represented by the zero-value elements. The client service module 170 can store the feature vectors for the users in the metadata database 160 as well.

Based on the metadata of the media objects and the feature vectors of the users, the client service module 170 can recommend media objects in various ways.

FIG. 7 illustrates an example of a process of recommending a media object to a user, according to various embodiments. Initially, the client service module 170 determines a current feature vector of the user (step 710). The element values of the feature vector represent the particular user's relationships with the metadata represented by the elements. An example of a feature vector is illustrated in FIG. 6. If the metadata database 160 stores the feature vector for the particular user, and assuming the feature vector is up-to-date, the client service module 170 can retrieve the feature vector from the database 160. If the metadata database 160 does not store the feature vector for the particular user, the client service module 170 can generate the feature vector, e.g., in a way illustrated in FIG. 6.

Then the client service module 170 determines one or more neighboring users of the particular user in various ways. For example, the client service module 170 identifies one or more neighboring users based on the vector distances between these various features vectors through a K-nearest neighbors algorithm (step 720). In this case, the service can select a group of users that minimize a distance function on a subset of the feature vector. For example, the service can use a Jaccard distance function over the elements of the feature vector that correspond with the classified categories. The result will be a group of users that have similar tastes in regard to the predefined categories.

Alternatively, the client service module 170 can examine the feature vector of the particular user, and identify one or more elements representing other users that have the highest affinity values. Client service module 170 then selects these users represented by the elements with highest affinity values.

Subsequently, the client service module 170 determines media objects that have high affinity values with the neighboring users based on the user vectors of the neighboring users (step 730). The client service module 170 selects media objects that have the highest collective affinity values under a collaborative filtering scheme (740). The client service module 170 then sends the selected media objects to a client device (e.g., 192 or 194) as recommendations (step 750).

FIG. 8 illustrates another example of a process of recommending a media object, according to various embodiments. Initially, the client service module 170 determines a feature vector of the user (step 810). Then the client service module 170 calculates vector distances between the user feature vector and media object feature vectors (step 820). Notice that metadata of a media object stored in the database 160 form a feature vector in the same vector space of the user feature vector. In other words, user feature vectors and media object feature vector can have the same types of elements (e.g., representing the same set of global tags, categories, or user identities), but have different element values (e.g., confidence weight values, category weight values, or affinity values).

The client service module 170 selects the media object feature vectors that have the lowest vector distances from the user feature vector (step 830). Then the client service module 170 sends the selected media objects to a client device (e.g., 192 or 194) as recommendations (step 840).

The ways of recommending media objects can vary. For instance, the processes illustrated in FIGS. 7 and 8 can be combined. The client service module 170 can consider both the affinities of the neighboring users and vector distances from the media objects when selecting media objects for recommendation. A score for each media object may be calculated based on the affinities between the media object and the neighboring users, as well as the vector distance between a media object feature vector and the feature vector of the particular user. Then the calculated scores for the media objects are used to select the recommendations of media objects.

FIG. 9 illustrates an example of a client device receiving a media object recommendation, according to various embodiments. The client device 900 includes a seamless media navigation application 910, a media object caching proxy 920, and a user input/gesture component 930. The user input/gesture component 930 is responsible for recognizing user inputs and gestures for operating the client device 900, and particularly for operating the seamless media navigation application 910 running on the client device 900. For instance, if the client device 900 includes a touch screen component, the user input/gesture component 930 recognizes the touch gestures when users touch and/or move the screen using fingers or styli. The user input/gesture component 930 translates the user inputs and gestures into commands 935 and sends the command 935 to the seamless media navigation application 910.

The seamless media navigation application 910 is responsible for playing media objects and navigating through different media objects and media channels. To play a media object, the seamless media navigation application 910 sends a media object request 915 targeting to a media content delivery server 940 that hosts the media object. The media object caching proxy 920 intercepts the requests 915 for the media object contents and relays the requests 915 to the media content delivery server 940 on behalf of the application 910. The media object caching proxy 920 receives and caches the media object content bytes 942 from the media content delivery server 940 in a local storage or memory. The proxy 920 then forwards the media object content bytes 942 to satisfy the requests 915 from the application 910 directly from the local storage or memory.

Since the media contents are pre-buffered locally by the proxy 920, the application can switch between media objects seamlessly. The proxy 920 is transparent to both the application 910 and the media content delivery server 940 as they are not necessarily aware of the existence of the proxy 920.

Based on the metadata of the user operating the client device 900 and/or metadata of media objects that are playing or have been played on the client device 900, the media content analysis system 950 sends media object recommendation 952 to the seamless media navigation application 910. The application 910 may present the recommendation to the user via an output component (e.g. display), and sends a request 915 for retrieving contents of the recommended media object.

The media object caching proxy 920 again intercepts the request and receives and caches the media object content bytes 947 from a media content delivery server 945. When the seamless media navigation application 910 switches between playing one media object to another media object based on user inputs, the application 910 can switch seamlessly without the need to wait for the content delivered from external servers, because the contents are pre-cached by the media object caching proxy 920.

FIG. 10 illustrates an example process for pre-caching online media objects, according to various embodiments. A proxy running on a computing device pre-buffers data of media objects for a media navigation application running on the computing device. The application generates requests to content provider servers for contents of media objects that are currently playing and are predicted to be relevant for future presentations. The proxy intercepts the requests for media contents and relays the requests to the content provider servers on behalf of the application. The proxy receives and caches in a local storage or memory the received media contents for media objects that are currently playing as well as ones are that may be played in future. The requests of the application to the provider servers are satisfied by retrieving the contents directly from the proxy. Since the media contents are pre-buffered locally by the proxy, the application can switch between media objects seamlessly. The proxy is transparent to both the application and the content provider servers as they are not necessarily aware of the existence of the proxy.

Initially, a proxy running on a computing device determines a first media object that a media navigation application running on the computing device is playing and a second media object that relates to the first media object (step 1010). The proxy further determines that the media navigation application likely switches from playing the first media object to playing the second media object (step 1015).

The proxy works as a middleman and is transparent to the media navigation application and external content servers. The media navigation application receives the data as if the data are directly retrieved from the one or more content servers, instead of the proxy. The one or more content servers send the data to the computing device as if the media navigation application directly receives the data. The media navigation application and the one or more media servers do not need to be aware of the existence of the proxy.

Then the proxy retrieves data of the first and second media objects on behalf of the media navigation application from one or more content servers (step 1020). For instance, when the media navigation application is playing the first media object at the first minute, the proxy may pre-buffer the next five minutes of contents of the first media object. The proxy may further pre-buffer the first two minutes of contents of the second media object so that the media navigation application can switching between the media objects without the need of waiting for the contents from external servers. The proxy stores the data of the first and second media objects in a buffer of the computing device (step 1025).

When the media navigation application intends to send a data request to the one or more content servers for the data of the media objects, the proxy intercepts the data request (step 1030). The proxy satisfies the data request for the first or second media object from the media navigation application by supplying the data stored in the buffer to the media navigation application (step 1035). The proxy may satisfy the data request by supplying the data of both the first and second media objects stored in the buffer to the media navigation application such that the media navigation application can play both media objects simultaneously.

The media navigation application of the computing device visualizes a transitional stage on a display of the computing device, wherein the transitional stage comprises a first section playing a portion of the first media object and a second section playing a portion of the second media object (step 1040). The media navigation application increases a size of the second section of the transitional stage until the second section occupies an entire display area of the transitional stage (step 1045).

In this way, the media navigation application seamlessly switches from playing the first media object to playing the second media object without delay in the media navigation application. The media navigation application can switch between media objects within a channel, or between media objects from different channels.

FIG. 11 illustrates an example graphical interface for seamless media object navigation, according to various embodiments. Such a graphic user interface (GUI) enables users to navigate between media objects in a seamless fashion on a computing device. The GUI allows a user to seamlessly switch between channels and/or between relevant media objects within a channel. For instance, a user may swipe up or down on a touch screen to switch channels, or swipe left or right to switch between relevant media objects. The media objects and channels can be pre-buffered so that a media object immediately starts to play on the computing device after the user switches contents, without a need to wait for the media object to be loaded or buffered. The GUI can provide additional gesture recognitions or input mechanisms to allow multiple media objects to be played simultaneously on a single screen. The user is able to organize and arrange how these media objects are playing by interacting with the GUI. The GUI may further generate relevant media objects (e.g., advertisements) to be displayed on top of the media objects that are currently playing.

For example, a media navigation application plays a first media object on a touch screen of the computing device. In response to a first swipe motion, the application gradually switches from playing the first media object to playing multiple media objects including the first media object on the touch screen. The first swipe motion can be, e.g., a swipe from a corner to a center of the screen. The borders between the multiple media objects move when a current position of the first swipe motion changes.

Then in response to a second swipe motion subsequent to the first swipe motion, the application gradually switches from playing the multiple media objects to playing one individual media object of the media objects on the touch screen. The second swipe motion can be, e.g., a swipe from the center to another corner of the screen. That individual media object is selected based on its relative position corresponding to the targeting corner.

FIG. 12 illustrates an example process for seamless media object navigation, according to various embodiments. Initially, the computing device retrieves data of the media objects from one or more media servers (step 1210), buffers the data of the media objects in a cache (step 1215), and loads the data of the media objects from the cache (step 1220).

Then the computing device visualizes on a display multiple sections playing multiple media objects simultaneously (step 1225). For example, at least one section of the sections can play a portion of the media object (instead of the entire display area of the media object). The portion of the media object can be determined, e.g., based on a position and a size of the section. Alternatively, one section of the sections playing the media objects can gradually increase its size until the section occupies the entire screen based on the swipe motion. The border between two sections of the sections can show a mix of contents of two media objects being played in the two sections.

The computing device receives a user input signal indicating a swipe motion (step 1230). The swipe motion can be generated, e.g., by swiping a finger or a stylus on a touch screen of the computing device.

The computing device continuously adjusts sizes of the sections based on a current position and a current direction of the swipe motion, wherein the sections continuously play the media objects when the sizes of the sections are being adjusted (step 1235). The computing device stops visualizing at least one of the sections when the user input signal indicates that the swipe motion reaches a border or a corner of the display (step 1240). The section (or sections) that remains on the screen plays the new media object replacing the original media object.

The online media content providers can supply tags or metadata associated with the online media objects to identify, describe and classify the contents of the media objects. The tags or metadata supplied by the online media content providers can be in forms of comments, blogs, web posts, and other types of written words or information. For instance, an online media content provider can host a comment that discusses a media object such as a video. The comment can include one or more tags or metadata that relate to the media object. However, these metadata are usually supplied in ways that are unique and specific to the content providers. The technology disclosed herein can collect the metadata from various content providers and normalize these source specific metadata into a group of universal tags for describing the online media objects regardless of the source content providers or the media types. The universal tags enable the online media objects to be organized and categorized based on a consistent way of identifying and describing the contents of the objects across various media content provider platforms.

FIG. 13 illustrates an example process for normalizing media object metadata, according to various embodiments. Initially, the process receives a plurality of web documents from web servers, the web documents referencing one or more media objects (step 1310). The media objects can be hosted by different web servers. The media objects can include different types of media objects, such as premium videos and user-generated videos. A premium video can be a professionally produced video, such as a move or a TV show episode.

Then the process extracts content tags from the web documents, the content tags relating to contents of the media objects (step 1315).

The process determines a set of media object metadata based on the content tags, wherein the set of media object metadata provides a consistent way of describing the contents of the media objects (step 1320). Such determining may include procedures such as disambiguating the content tags and/or stemming and lemmatizing the content tags. The step 1320 that normalizes the media object metadata may be performed by, e.g., a normalization module of a computing device.

For at least some of the media objects, the process stores the set of media object metadata and the values associated with the media object metadata in a media content database (step 1325). The media content database can includes values for different media objects. For example, the database can include a set of values associated with the set of media object metadata for a premium video, and another set of values associated with the same set of media object metadata for a user-generated video.

The process compares a first set of values for a first media object and a second set of values for a second media object to determine whether the two media objects are closely related (step 1330). The two media objects can be, e.g., a premium video and a user-generated video.

The process recommends at least one media object of the media objects based on the set of media object metadata and the values associate with the media object metadata for that media object (step 1335). For example, an advertisement module of a computing device may recommend an advertisement that relates to a media object, wherein values corresponding to the normalized tags for the advertisement are close to values corresponding to the normalized tags for the media object. Alternatively, a channel module may organize a channel including at least two media objects, wherein values corresponding to the normalized tags for the media objects are similar. The channel may include different types of media objects, such as a premium video and a user-generated video. Using an application illustrated in FIG. 11, a user can seamlessly navigate through the recommended media objects within one channel or across multiple channels.

FIG. 14 is a high-level block diagram showing an example of a processing system which can implement at least some operations related to media content analysis and recommendation, media object metadata normalization, media object buffering, or seamless media navigation. The processing device 1400 can represent any of the devices described above, such as a media content analysis system, a media content delivery server, a social media server, a general content server or a client device. As noted above, any of these systems may include two or more processing devices such as those represented in FIG. 14, which may be coupled to each other via a network or multiple networks.

In the illustrated embodiment, the processing system 1400 includes one or more processors 1410, memory 1411, a communication device 1412, and one or more input/output (I/O) devices 1413, all coupled to each other through an interconnect 1414. The interconnect 1414 may include one or more conductive traces, buses, point-to-point connections, controllers, adapters and/or other conventional connection devices. The processor(s) 1410 may include, for example, one or more general-purpose programmable microprocessors, microcontrollers, application specific integrated circuits (ASICs), programmable gate arrays, or the like, or a combination of such devices. The processor(s) 1410 control the overall operation of the processing device 1400. Memory 1411 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 1411 may store data and instructions that configure the processor(s) 1410 to execute operations in accordance with the techniques described above. The communication device 1412 may include, for example, an Ethernet adapter, cable modem, Wi-Fi adapter, cellular transceiver, Bluetooth transceiver, or the like, or a combination thereof. Depending on the specific nature and purpose of the processing device 1400, the I/O devices 1413 may include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method for normalizing media object metadata, comprising:
receiving a plurality of web documents from web servers, the web documents referencing one or more media objects;
extracting content tags from the web documents, the content tags relating to contents of the media objects;
determining a set of media object metadata based on the content tags, wherein the set of media object metadata provides a consistent way of describing the contents of the media objects; and
for at least some of the media objects, storing the set of media object metadata and the values associated with the media object metadata in a media content database.

2. The method of claim 1, further comprising:
recommending at least one media object of the media objects based on the set of media object metadata and the values associate with the media object metadata for that media object.

3. The method of claim 2, wherein the media objects are hosted by different web servers.

4. The method of claim 2, wherein the media objects comprise premium videos and user-generated videos.

5. The method of claim 4, wherein the premium videos comprise movies or TV show episodes.

6. The method of claim 4, wherein the media content database includes a first set of values associated with the set of media object metadata for a premium video, and a second set of values associated with the same set of media object metadata for a user-generated video.

7. The method of claim 6, further comprising:
comparing the first set of values and the second set of values to determine whether the premium video and the user-generated video are closely related.

8. The method of claim 1, wherein the determining comprises:
disambiguating the content tags.

9. The method of claim 1, wherein the determining comprises:
stemming and lemmatizing the content tags.

10. The method of claim 1, wherein the set of media object metadata is used to describe contents of various types of media objects from different providers.

11. The method of claim 1, wherein the set of media object metadata comprises:
global tags selected from the content tags;
categories of a machine learning classifier; and
user identities.

12. The method of claim 11, wherein the values associated with the set of media object metadata comprises:
confidence weight values associated with the global tags indicating confidence levels confirming a media object relates to the corresponding global tags;
category weight values generated by the machine learning classifier indicating confidence levels confirming the media object belongs to the corresponding categories; and
affinity values associated with the user identities indicating how closely the media object relates to the corresponding user identities.

13. The method of claim 1, wherein the web documents include:
HyperText Markup Language (HTML) documents;
Extensible Markup Language (XML) documents;
JavaScript Object Notation (JSON) documents;
Really Simple Syndication (RSS) documents; or
Atom Syndication Format documents.

14. A computing device for normalizing media object metadata, comprising:
a processor;
a network interface for retrieving a plurality of web documents from multiple web servers, the web documents referencing one or more media objects;
a normalization module configured, when executed by the processor, to normalize a set of tags based on textual contents of the web documents, wherein the set of normalized tags provide a universal metadata set for annotating the media objects; and
a media content database for storing the set of normalized tags and values corresponding to the normalized tags for describing contents of the media objects.

15. The computing device of claim 13, further comprising:
an advertisement module configured, when executed by the processor, to recommend an advertisement that relates to a media object, wherein values corresponding to the normalized tags for the advertisement are close to values corresponding to the normalized tags for the media object.

16. The computing device of claim 13, further comprising:
a channel module configured, when executed by the processor, to organize a channel including at least two media objects, wherein values corresponding to the normalized tags for the media objects are similar.

17. The computing device of claim 16, wherein the channel includes a professionally produced video and a user-generated video that relates to the professionally produced video.

18. A non-transitory computer-readable storage medium storing instructions for normalizing media content metadata, comprising:
instructions for receiving a plurality of web documents from web servers, the web documents referencing one or more media objects;
instructions for extracting content tags from the web documents, the content tags relating to contents of the media objects; and
instructions for determining a set of media object metadata based on the content tags, wherein the set of media object metadata provides a consistent way of describing the contents of the media objects.

19. The storage medium of claim 18, further comprising:
instructions for recommending one or more related media objects based on the values associated with the media object metadata for the related media objects.

20. The storage medium of claim 18, further comprising:
instructions for generating confidence weight values associated with the global tags indicating confidence levels confirming a media object relates to the corresponding global tags, wherein the set of media object metadata includes the global tags;
instructions for generating category weight values by feeding the web documents referencing the media object through a machine learning classifier trained with multiple categories, the category weight values indicating confidence levels confirming the media object belongs to the corresponding categories, wherein the set of media object metadata includes the categories; and
instructions for generating affinity values associated with the user identities indicating how closely the media object relates to the corresponding user identities, wherein the set of media object metadata includes the user identities.
